(19) United States
(12) Patent Application Publication
(10) Pub. No.: US 2024/0050925 A1
(43) Pub. Date: Feb. 15, 2024

(54) METHOD FOR MODIFYING A POLYMER SUPPORT MATERIAL, POLYMER SUPPORT MATERIAL OBTAINABLE BY SUCH METHOD, CHROMATOGRAPHY COLUMN, METHOD OF CHROMATOGRAPHIC SEPARATION AND USE OF A POLYMER SUPPORT MATERIAL

(71) Applicant: METROHM AG, Herisau (CH)

(72) Inventors: Alexandra ZATIRAKHA, Moscow (RU); Andrea AESCHLIMANN, Herisau (CH); Bastian BRAND, Siebnen (CH); Brigitte LAMERS, Herisau (CH)

(73) Assignee: METROHM AG, Herisau (CH)

(21) Appl. No.: 18/258,715

(22) PCT Filed: Dec. 21, 2021
(86) PCT No.: PCT/EP2021/087072

§ 371 Date: Jun. 21, 2023

(30) Foreign Application Priority Data
Dec. 22, 2020 (EP) 20216627.8

(51) Int. Cl. B01J 20/289; B01J 20/26; B01J 20/32; B01D 15/36

(52) U.S. Cl. CPC B01J 20/289; B01J 20/267; B01J 20/3282; B01J 20/3212; B01J 20/3219; B01J 20/3293; B01D 15/361; B01J 2220/54

(57) ABSTRACT

A method for modifying a support material, in particular a polymeric support material, for use as a stationary phase in an analytical or preparative separation process. The method includes the steps of providing a support material, coating the support material with an oligoamine or polyamine and reacting the support material with a compound comprising a first functional group reactive with amines and/or hydroxy group and an ion-exchange group. Additionally a support material, a chromatography column, a method of chromatographic separation of analytes and the use of such support material.

The present invention relates to a method for modifying a polymer support material for use as a stationary phase in an analytical or preparative separation process. The invention further relates to a polymer support material obtainable by such method. The invention further relates to a chromatography column filled with polymer support material, a method of chromatographic separation of analytes and the use of such polymer support material for the separation of analytes, in particular for use in anion exchange chromatography, cation exchange chromatography and/or HILIC chromatography.

Ion exchangers are usually made of particulate materials, which carry charges on their surface that enable them to retain ions. Anion exchangers are often based on cationic ammonium compounds, although phosphonium and arsonium ions are also known. For purely electrostatic interactions, the retention time is determined by Coulomb's law. Accordingly, only the charge of the anion should affect the retention time of the latter. However, when ion chromatography is performed in aqueous solution, other factors affect the retention behavior, such as the hydration of the anion and the hydration of the exchange group. The polarizability of the ions involved and weaker secondary interactions between the analytes and the exchange substrate also play a role.

Carbonate and hydroxide solutions are the most common eluents used in suppressed anion-exchange chromatography, however, within the last decade the trend was shifting more and more toward the development of hydroxide-selective anion-exchange columns. The advantage of hydroxide eluent over carbonate eluent is as follows: possibility to use gradient elution for the simultaneous separation of weakly and strongly retained compounds, lower background conductivity and thus higher sensitivity of analysis. Another advantage is that hydroxide eluent provides good resolution of fluoride from void volume, which is often a problem when using carbonate eluent. Also, some norms for monitoring disinfection by-products in water recommend hydroxide eluent.

Columns for the use in suppressed IC mode with hydroxide eluent should be stable at high pH up to 14, which is usually provided by using aromatic substrates such as DVB-based copolymers, and possess high surface hydrophilicity provided by the respective anion-exchange coating, which increases elution power of hydroxide ion and column efficiency for highly polarizable anions such as nitrate, iodide, perchlorate etc.

A packing material based on aromatic copolymer with hydrophilic anion-exchange coating is disclosed in Analytica Chimica Acta, 964, (2017) 187. This reference describes the PS-DVB-based anion exchanger, where the anion-exchange coating bonded to the substrate through 1,4-butanediol diglycidyl ether as a linker is formed by attaching polyethyleneimine and crosslinking and quaternizing it by reacting with 1,4-butanediol diglycidyl ether. Such material possesses rather good selectivity for the separation of standard inorganic anions and some organic acids, but capacity of the resin is defined by the crosslinking degree of polyethyleneimine with 1,4-butanediol diglycidyl ether and, therefore, cannot be adjusted independently from column selectivity in the proposed preparation method.

Very similar packing material with polyethyleneimine-based coating is disclosed in WO 2020/044813A1, where polyethyleneimine coated substrate is subsequently reacted with diglycidyl ether and tertiary amine. However, in the proposed approach desired functionalities are only formed when certain ratios of polyethyleneimine and diglycidyl ether are used, and crosslinking is highly probable under the described reaction conditions. This affects selectivity and creates additional capacity because of unavoidable quaternization of amino groups in polyethyleneimine, therefore, selectivity and capacity cannot be varied independently. Also, early elution of divalent sulfate on the reported packing material under the optimized testing conditions may cause problems with quantification of neighboring analytes (for example, ClO₃⁻ and NO₂⁻) that are present in much lower quantities in real samples.

Another way to prepare hydrophilic coatings for aromatic substrates to be used with hydroxide eluent in suppressed ion chromatography is proposed in Journal of Chromatography A 1213 (2008) 37 and US 2005/0181224A1 and includes step-by-step growth of positively charged hyperbranched layer on the surface of sulfonated EVB-DVB by repeating the modification cycles including reactions with primary amines and diglycidyl ethers. The prepared materials possess good selectivity and high capacity, which can be increased by increasing the number of modification cycles (branching degree). However, increasing the number of cycles leads not only to capacity, but also to selectivity change due to the fact that crosslinking process becomes more likely. Therefore, those parameters cannot be controlled independently from each other. Also, preparation of such coatings providing good selectivity includes many synthesis steps (usually, more than 8), which makes the reproducibility of the coating more difficult.

Efforts have been made to provide particularly stable support particles, preferably support particles having a hydrophobic core which can be (surface-)modified to achieve certain desirable properties in separation processes. For example, PCT/EP2020/059908 teaches a modified support material for use in separation methods having adjustable hydrophilicity, balanced capacity, high number of theoretical plates, chemical inertness and high mechanical stability. The modified support material according to the said publication works well for ion chromatography separations using carbonate eluents, while the use of hydroxide eluent results in co-elutions of some pairs of analytes that are well resolved with carbonate, which limits the applicability of such material for solving key analytical tasks in industry.

US 2008/203029 discloses polymeric chromatographic media for bio-separations which are prepared by using polymeric particles derivatized with polyethyleneimine further functionalized with appropriate reactants. EP2060316 discloses media for chromatographic applications, wherein the media is a membrane for chromatographic purification of virus having a surface coated with polyethyleneimine. The immobilized PEI is modified with a charge-modifying agent to impart quaternary ammonium functionality to the media. CN105396628 relates to a 2,3-epoxypropyltrimethyl ammonium chloride modified PEI graftmodified PS/DVB ion chromatographic packing. PS/DVB microspheres serve as a carrier substrate. They are initially modified by methacrylic acid glycidyl ester to provide epoxy groups for further reaction steps. U56780327 provides a positively charged microporous membrane comprising a hydrophilic porous substrate and a crosslinked coating comprising pendant cationic groups. None of these publications provides a mechanically and chemically stable particle, suitable for ion exchange chromatography and produced in a method such that hydrophilicity, capacity and selectivity can be configured independently of each other.

It is an object of the present invention to overcome the disadvantages in the state of the art. In particular, it is an object of the present invention to provide a polymer support material modified such that the hydrophilicity of the material can be adjusted independently of the oxygen content in the polymer core substrate, resulting in a mechanically stable and robust particle, while providing well reproducible properties from one batch to the other. Furthermore, an ion exchanger based on the polymer support material should be provided which is chemically largely inert and wherein hydrophilicity, capacity and selectivity can be configured independently from each other.

The object is achieved by a modification method, a polymer support material, a chromatography column, a separation method and the use of a polymer support material having the features of the independent claims. However, the applicability of the present invention is not limited to the hydroxide eluent only.

A first aspect of the invention refers to a method for modifying a support material, in particular a polymer support material for use as a stationary phase in an analytical or preparative separation process. The method comprises the steps of:
a) providing a support material,
b) coating the support material with an oligoamine or polyamine, and
c) reacting the support material with a compound comprising
   a first functional group reactive with amines and/or hydroxy groups, preferably an epoxy group, and
   an ion-exchange group, preferably a quaternary organo-element of main group V, preferably a quaternary ammonium group.

Steps b) and c) are performed in sequence or simultaneously, preferably sequentially. Regarding the simultaneous performance, the support material is mixed with the oligoamine or polyamine and with a compound comprising a first functional group reactive with amines and/or hydroxy groups, preferably an epoxy group, and an ion-exchange group, preferably a quaternary organo-element of main group V, preferably a quaternary ammonium group in one step. Alternatively, the oligoamine or polyamine and the compound comprising the first functional group reactive with amines and/or hydroxy groups, preferably an epoxy group, and an ion-exchange group, preferably a quaternary organo-element of main group V, preferably a quaternary ammonium group, are mixed in a first step and the support material is added to that mixture in a second step.

The coating in step b) can be a covalent or electrostatic coating.

The support material provided in step a) is preferably either directly coated with a polyamine or a spacer can be provided between the support material and the polyamine as outlined in detail further below. The polyamine can be selected from the group consisting of polyallylamine, linear or branched polyethyleneimine (PEI), poly(2-methylaziridine); preferably a branched PEI. A branched PEI may be used, particularly preferably a branched PEI having an average molecular weight Mw between 600 and 1800 Da (by light scattering LS) and an average Mn between 400 and 1600 Da (by gel permeation chromatography GPC). Each molecule of PEI can have several attachment points, since several amine groups of one molecule can react with groups reactive with amine groups. The reactive groups can be provided by the support material provided in step a.

It is an advantage of the method according to the invention that a polymer support material can be obtained which is highly reproducible. Due to the amine coating, in particular PEI coating, previous steps of hydrophilizing the surface of a hydrophobic core have only minimum impact on the properties and performance of the resulting material, while still resulting in a mechanically stable and robust particle.

It is a particular advantage of the polymer support material that it can be further treated to be used as a stationary phase in anion exchange chromatography. However, the use of the particles is by no means limited to this. The particles can alternatively be used in other analytical and preparative separation methods, such as cation exchange chromatography, other adsorption chromatography methods, HILIC chromatography (hydrophilic interaction liquid chromatography), reversed phase chromatography, solid phase extraction, etc.

Hydrophilicity, capacity and selectivity are independently adjustable in such an ion exchange material. Ion exchange groups are charged groups on the polymer support material's surface, especially charged amine or phosphine groups, in particular quaternary ammonium groups.

By varying the amount of ion exchange groups, the capacity of the separation material can be adjusted and regulated. The support material is turned into a material suitable for ion exchange interaction, in particular ion exchange chromatography.

Due to the reaction with PEI, capacity and selectivity of an ion exchange material, which is based on the polymer support material, can be adjusted independently of each other.

In addition, due to the reaction with PEI, an ion exchanger material, which is based on the polymer support material as described above, avoids problematic co-elution with regard to oxohalides and certain haloacetic acids, such as DCA (dichloroacetic acid), MCA (monochloroacetic acid), MBA (monobromoacetic acid), DCA (dichloroacetic acid), DBA (dibromoacetic acid), TCA (trichloroacetic acid). In fact, a polymer support material according to the present invention can serve as a basis to produce an anion exchanger which allows for the separation of five haloacetic acids in addition to the inorganic standard ions and oxohalides, preferably by using gradient elution with KOH. To our knowledge, there is for the first time reported a column providing for baseline separation of ClO₂⁻, MCA, BrO₃⁻ and MBA.

Some other problems persisting in the art can also be overcome. The effect of coating a polymer particle mainly by means of 1,4-BDDGE has proven to be too dominant and the selectivity towards inorganic anions is therefore hard to control. These problems have been resolved by means of a support material as presently disclosed. The tendency of DCA to co-elute with chlorate (in KOH eluent, methylmorpholine(MM)-quarternised material) is remedied. Similar problems encountered when chlorite and bromate are to be separated in the presence of other functionalities (N-Methylpyrrolidone (NMP), N-methyl-diethanolamine (MDEA)) are overcome by means of a support material as presently disclosed. The challenge of controlling the selectivity, especially for Br⁻, NO₃⁻, ClO₃⁻ and DCA has been lessened.

By using the polymer support material as an ion exchange stationary phase, a high number of theoretical plates per column meter (>50,000 TP/m) for the seven standard anions (fluoride, chloride, nitrite, bromide, nitrate, phosphate and sulphate) with high signal symmetries (asymmetry <1.5) can be obtained.

All above-mentioned ions appear baseline separated from each other in the chromatogram with a short total running time of the chromatography.

Preferably, step c) is followed by a crosslinking step d) treating the reaction product resulting from step c) with one or more polyfunctional compounds, in particular with a compound having
at least a first functional group reactive with amines and/or hydroxy groups, preferably an epoxy group, and
at least a second functional group reactive with amines and/or hydroxy groups, preferably an epoxy group.

This step causes a significant shift of selectivity in the chromatogram obtainable by such an ion exchanger. Resolution of Br⁻/NO₃⁻ and DCA/ClO₃⁻ is enabled or optimized by using a polymer support material obtainable after step d) as an ion exchanger material, particularly in KOH eluent.

It is particularly preferred that steps b) c) and d) are performed sequentially in the indicated order. If step d) is performed previous to step c) in the sequential process, the capacity lowers drastically, and all ions of interest co-elute with each other. This is due to the loss of available reactive sites for the ion exchange moiety when the polymer material is first reacted with the crosslinker molecule. The availability of those sites is reduced due to the covalent attachment of the crosslinker molecule to PEI and the crosslinking causes a network formation of the shell, shielding the PEI from reacting with the ion exchange molecule.

If steps b) c) and d) are performed simultaneously, e.g. in a one-pot-reaction with a polyamine of a molecular weight between 600 and 1800 Da and a reaction time such that 0.90-1.33% N, preferably 1.00-1.28% N, particular preferably 1.15-1.25% N has been reacted onto the polymer material, the resulting polymer support material gives a chromatogram in which DCA, chlorate and bromide co-elute and chlorite co-elutes with bromate. Co-elution can be solved by the material resulting from the sequential process. Moreover, the capacity lowers in the simultaneous process, and the product is not as reproducible compared to the product resulting from the sequential process.

If steps b) and c) are performed simultaneously in a one-pot reaction with a polyamine, preferably PEI, of a molecular weight between 600 and 1800 Da and a reaction time such that 0.90-1.33% N, preferably 1.00-1.28% N, particular preferably 1.15-1.25% N has been reacted onto the polymer material, and step d) sequential to those steps, a column material with comparable capacity is obtained, but changes in selectivity are obtained resulting in co-elution of DCA with NO₂⁻.

Furthermore, the two one-pot procedures described above give ion exchangers which are not suitable for the separation of all five haloacetic acids, the inorganic standard ions and oxohalides in gradient elution with KOH as a clean separation of ClO₂⁻, MCA, BrO₃⁻ and MBA is not possible.

Preferably, the compound used in step c) is of Formula I

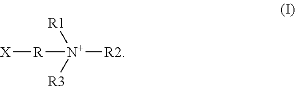

R can be a linear or branched alkyl or ether group. It is possible to provide an ether group with one or more ether moieties, preferably two ether moieties.

R1, R2 or R3 can be selected independently from the group consisting of substituted or unsubstituted alkyl, substituted or unsubstituted heteroalkyl, substituted or unsubstituted aryl, substituted or unsubstituted heteroaryl, substituted or unsubstituted heterocycloaklyl or five- or six-membered heterocycle formed between R1 and R2 or R2 and R3 or R1 and R3.

X can be a functional group reactive with amines and/or hydroxyl groups, preferably an epoxy group or halogenide. But other reactive groups are also possible, such as tosylates or mesylates.

Advantageously, the compound is of Formula I and R is selected from the linear or branched alkyl or ether group consisting of —(CH₂)ₙ— or —(CH₂)ₙ—O—(CH₂)ₙ— with n being selected from 1, 2, 3, 4, 5, 6, 7, 8, 9, 10. R1, R2 and R3 each or independently can be
an alkyl group selected from the group consisting of —CH₃ and —(CH₂)ₙ—CH₃, with n being selected from 1, 2, 3, 4, 5, 6, 7, 8, 9, 10; or
an alkyl alcohol group selected from the group of linear or branched alkyl alcohols, preferably selected from the group consisting of —(CH₂)ₙ—OH . . . , with n=being selected from 1, 2, 3, 4, 5, 6, 7, 8, 9, 10.

The compound can be of formula II, III or IV

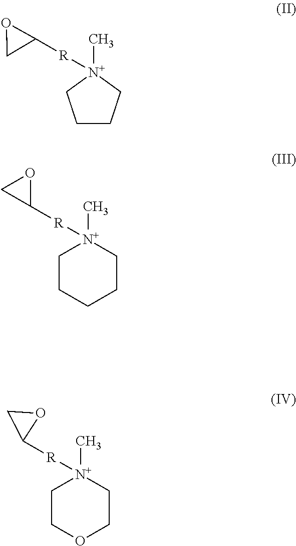

with R being selected from the linear or branched alkyl or ether group consisting of —(CH₂)ₙ— or —(CH₂)ₙ—O—(CH₂)ₙ— with n being selected from 1, 2, 3, 4, 5, 6, 7, 8, 9, 10.

Preferably, the compound used in step c) is of Formula (I), selected from the group consisting of glycidyltrimethylammonium chloride; glycidylmethyldiethanolammonium chloride; and glycidyltriethylammonium chloride.

Preferably, the compound used in step c) is a (Halogenoalkyl)trialkylammonium halogenide selected from the group consisting of: (3-Chloro-2-hydroxypropyl)trimethylammonium chloride, (2-Chloroethyl)trimethylammonium chloride, (2-Bromoethyl)trimethylammonium bromide, (3-Bromopropyl)trimethylammonium bromide, (5-Bromopentyl)trimethylammonium bromide.

A crosslinking step d) can follow after step c) of the method. As outlined above, the reaction product resulting from step c) can be treated with one or more polyfunctional compounds, in particular with a compound having
at least a first functional group reactive with amines and/or hydroxy groups, preferably an epoxy group, and
at least a second functional group reactive with amines and/or hydroxy groups, preferably an epoxy group.

In this case, the polyfunctional compound(s) is/are preferably selected from
epoxides, in particular 1,4-butanedioldiglycidyl ether, trimethylolpropane triglycidyl ether, poly(ethylene glycol) diglycidyl ether, resorcinol diglycidyl ether, glycerol diglycidyl ether, glycidol;
halogenalkanes, in particular epichlorohydrin, epibromohydrin, 1,1′-Oxybis[2-(2-chloroethoxy)ethane], 1,2-Bis(2-chloroethoxy)ethane, bis(2-chloroethyl) ether, 1-Chloro-3-iodopropane, 1,4-dibromobutane, 1,3-dibromopropane;
aldehydes, in particular glutaraldehyde.

The effect of this step shows a significant shift of selectivity in the chromatogram obtainable by such an ion exchanger. Resolution of Br⁻/NO₃⁻ and DCA/ClO₃⁻ is achieved using a polymer support material obtainable in step d) as an ion exchanger material in KOH eluent. The advantage of BDDGE is its hydrophilicity which enables the tuning of the selectivity of the ions in the chromatogram.

Alternatively, the effect can also be achieved if the crosslinking step with a polyfunctional compound is replaced by treatment of the reaction product from step c) with one or more monofunctional compounds, in particular with a compound having a functional group reactive with amines and/or hydroxy groups. The monofunctional compound(s) is/are preferably selected from the group consisting of substituted or unsubstituted alkyl, substituted or unsubstituted heteroalkyl, substituted or unsubstituted aryl, substituted or unsubstituted heteroaryl, substituted or unsubstituted heterocycloaklyl and most preferably selected from halogene alkanes or epoxy alkanes, in particular iodooctan or 1,2-epoxyoctane.

The PEI can be covalently attached to the support material. This results in a polymer material which is stable up to pH 14. Preferably the PEI is attached to the support material, which is preferably a polymeric support material, by means of a spacer molecule.

The spacer molecule can be a polyfunctional molecule with a group reactive with alcohols/amines (the substrate functionality) and the other group reactive with polyamine.

Preferably, the support material provided in step a) comprises groups that are reactive with the spacer molecule on the substrate surface.

For the purposes of this invention, a spacer molecule (or spacer) means a molecule comprising at least two functional groups as described above, and the molecule ensures a spacing of at least 3 atoms, preferably from 3 to 20 atoms, between the support material and the oligoamine or polyamine, preferably PEI. The functional groups of the spacer molecule can be functional groups which are susceptible towards a nucleophilic attack by OH-groups or amine groups, such as halogenated hydrocarbons, epoxides, tosylates, methyl sulfides or combinations thereof. The spacer atoms may be built by carbon atoms, but carbon chains may also include heteroatoms to give ether groups or thioethers. The spacer molecule creates a spacing between the support material and outer layers of polymers, monomers or modifications, e.g. ion exchange groups. Spacer molecules prevent interaction between analytes and polymer support substrate and thus reduce undesirable peak broadening in a chromatogram obtainable by means of the said polymeric support material. Spaced carbon chains with ether groups are preferred due to their higher hydrophilicity. As an example, the spacer may have glycidyl groups which are reactive with amines and/or hydroxy groups, such as 1,4-butanediol diglycidyl ether.

Preferably, the support material provided in step a) comprises groups that are reactive with epoxides, in particular hydroxyl groups.

The support material provided in step a) can be selected from the group consisting of hydrocarbon-based compounds, in particular aromatic hydrocarbon-based compounds; PVA; sugar-based compounds; inorganic compounds, in particular silica, zirconia, aluminia, titania.

In order to provide a possibility to use the prepared material in suppressed ion chromatography mode, the support particles should be compatible with high concentrations of hydroxide eluent with pH up to 14. For this reason, the most suitable support particles are aromatic divinylbenzene-based copolymers with high crosslinking degree (defined by DVB monomer content). However, high hydrophobicity of such aromatic substrates requires hydrophilization procedure to be conducted in order to achieve better column efficiency and to introduce anchor groups for the functional layer attachment. The procedure combining both aspects is disclosed in PCT/EP2020/059908.

The method can comprise the step of generating hydroxy groups on/in the support material, before step b), by a process comprising the steps of
oxidative treatment of a polymer support substrate; and subsequent
reductive or hydrolytic treatment.

The oxidative treatment can be a treatment with a per-acid, preferably selected from the group of meta-chloroperbenzoic acid, peroxy formic acid, peracetic acid, peroxytrifluoroacetic acid, a treatment with KMnO₄, a treatment with oxygen plasma or a combination thereof.

By using a per-acid, double bonds are oxidized and made accessible for subsequent reduction or hydrolysis. It goes without saying that the effect can also be achieved by other oxidative processes known to those of skill in the art, such as ozonolysis. It is particularly preferred that a per-acid is used because high oxygen contents can be achieved. With oxygen plasma, oxygen contents of 2.0% on the support substrate's surface can be achieved, whereas with m-CPBA, for example, oxygen contents of 3.2% and more can be achieved, measurable by elemental analysis. If a per-acid is used, it can be added to the polymer in suspension or formed in situ from an acid and hydrogen peroxide. Preferably, m-CPBA is added to the suspended core polymer support substrate, e.g. PS/DVB polymer substrate. Oxygen content of at least 2% can be achieved, measurable by elemental analysis.

In a preferred embodiment, the reductive treatment of the reaction product is carried out by means of a reagent for the reduction of polar bonds, preferably with a metal hydride. For example, NaBH₄, BH₃, LAH, NaH, CaH can be used. The use of hydrides has the advantage that the dissolved reagent can penetrate into the pores of the particle. This is not possible with palladium on activated carbon, for example. Compared to hydrolysis with hydrochloric acid, which hydrolyses epoxides to hydroxylene, reduction with metal hydrides can also convert carbonyls and carboxyls. The reduction converts the formed oxidation products into alcohols. Lithium aluminum hydride is preferably used in ether. For example, to a 1-20% w/v polymer suspension in dry tetrahydrofuran (THF) a 5-100% w/w of the polymer (dry) of lithium aluminum hydride may be added. Preferably, to a 5-15% w/v polymer suspension in dry THF a 5-20% w/w of the polymer (dry) of lithium aluminium hydride may be added. Typical temperatures range from 25-70° C., especially preferable is the boiling temperature of THF, and a reaction time of 1 min to 72 h, especially preferably 3 h to 48 h.

Advantageously, the reaction product resulting after the reductive or hydrolytic treatment is pressure-stable at pressures up to 220 bar, preferably up to 250 bar, particularly preferably at pressures up to 300 bar. Pressure stability is understood here to mean that the pressure increase as a function of the flow rate is only linear. The good pressure stability results from small particle diameter size and micro-/mesoporosity of a particle structure as explained below.

The support material is preferably
partially derived from aromatic hydrocarbon compounds having at least two vinyl or allyl substituents, preferably at least partially derived from divinylbenzene monomers; and
partially derived from monomers selected from the group of ethylvinylbenzene, vinyl acetate, styrene and any combination thereof.

The relative amount of aromatic hydrocarbon compounds having at least two vinyl or allyl substituents, preferably the relative amount of divinylbenzene derived monomers is preferably at least 50% by weight.

Such a support material is derived essentially completely from compounds which do not contain oxygen atoms, so that a mechanically and chemically stable particle core is obtained that is compatible with the high concentrations of hydroxide eluent present in suppressed ion chromatography.

In a preferred embodiment, step c) or d) of the method as described above is followed by a step e) heating the functionalized and crosslinked material in alkaline solution. This allows the selectivity and capacity of the ion exchange material from the previous step to be adjusted. The treatment is hereinafter referred to as elimination and consists in particular of heating the particles provided with exchanger groups in aqueous alkaline solution, particularly preferably of heating in an aqueous solution of alkali or alkaline earth metal hydroxide or carbonate, for example in sodium hydroxide solution. The preferred concentration of NaOH is in the range of 0.1 to 5 mol/L base, particularly preferred is 0.2 to 2 mol/L base. The reaction temperature may be 20-100° C., particularly preferred is 20-40° C., with a treatment time of 0.1-150 h, particularly preferred 12-24 h.

The elimination step alters the relative intensity of the interaction of the substrate with individual ions. In particular, secondary interactions with polarisable analytes can be reduced. The tailing of the signal peaks, which is observed due to such secondary interactions, decreases so that polarisable ions also elute symmetrically. At the same time, the electrostatic interaction capacity of the column is also reduced after elimination and the total capacity of the ion exchange material decreases.

A second aspect of the invention refers to a support material for use as a stationary phase in an analytical or preparative separation process, in particular a chromatography process, obtainable by a method as previously described.

Advantageously, the support material provided in step a) is microporous and/or mesoporous.

It is particularly preferred that the polymer support material as claimed is based on a polymer support substrate which is microporous and/or mesoporous. It is particularly preferred that the polymer support substrate is hydrophobic. By hydrophobic is meant here that the polymer support material is non-polar, i.e. has no monomer units with a dipole moment >0.2 D. Microporous and/or mesoporous means here that the polymer support material has an average pore diameter of at most 50 nm, measurable by nitrogen sorption in the BJH model.

The support material is preferably present as particles, more preferably as spherical particles, particularly preferably as spherical particles having an average particle size of 1 to 50 μm, more preferably 2 to 25 μm, particularly preferably 3 to 9 μm. Particle size is defined here as an average value between the longest and shortest straight line through the centre of the particle, measurable by scanning electron microscopy (SEM) and automated image evaluation.

The size of the particles can be adjusted by suitable stirring speed, choice of solvent, concentration of the polymer in the solvent, etc. The procedures are known to the expert. A polymer support material of this shape and size has a volume/surface area ratio which has proven to be particularly advantageous for the exchange capacity. It exhibits high diffusivity into the pores and is easy to pack.

Preferably, the polymer support material is stable in a pH range from 0 to 14, in particular such that the retention time of sulfate in a column packed thereof after one-time rinsing with 1M NaOH solution and/or one-time rinsing with 1M HNO₃ solution does not differ by more than 8%, preferably by more than 5%, particularly preferably by more than 3% from the retention time of sulfate before such rinsing. The measuring method for pH stability is performed as follows: The sample is packed into a chromatography column and the retention time of sulphate is determined from ten measurements with an eluent of 6 mmol/L Na₂CO₃ and 1 mmol/L NaHCO₃. The column is then rinsed for 14 h with an eluent of 6 mmol/L Na₂CO₃ and 1 mol/L NaOH (pH 14) at 0.8 mL/min. Then more measurements of the sulphate retention time are performed with an eluent of 6 mmol/L Na₂CO₃ and 1 mmol/L NaHCO₃. The column is then flushed for 14 h with an eluent of 6 mmol/L Na₂CO₃ and 1 mol/L HNO₃ (pH 0) at 0.8 mL/min. Then 10 more measurements of the sulphate retention time are performed with an eluent of 6 mmol/L Na₂CO₃ and 1 mmol/L NaHCO₃. Each time the eluent is changed, the column is rinsed with water for 1 h to avoid precipitations. A possible change is investigated on the basis of retention time and plate numbers of sulphate; both parameters deviated by a maximum of 3% from the originally determined values after both basic and acidic treatment.

The polymer support material as previously described can derive from a polymeric support substrate which is substantially entirely composed of monomer units selected from the group of:
monomer units derived from aromatic hydrocarbon compounds having at least two vinyl or allyl substituents, preferably derived from divinylbenzene;
monomer units derived from ethylvinylbenzene;
monomer units derived from styrene;
a combination thereof.

By “substantially entirely composed of” is meant that the total proportion of the listed monomer units in the polymer support material provided in step a amounts to at least 95% by weight, preferably at least 98% by weight, particularly preferably at least 99% by weight. In other words, the monomer units can be derived essentially completely from compounds which do not contain oxygen atoms, so that a hydrophobic particle core is obtained.

The polymeric support substrate can have an average pore radius of 1 to 50 nm, preferably of 2 to 25 nm, particularly preferably 2 to 10 nm, measurable by nitrogen sorption in the BJH model. The measurement is performed as described in the examples.

Preferably, the polymeric support substrate has a specific surface area of 80 to 1000 m2/g, preferably of 100 to 800 m2/g, even more preferably of 200 to 600 m2/g, measurable by nitrogen sorption in the BET model. The measurement is performed as described in the examples.

The high specific surface area increases the capacity and resolution of the column, especially when separating small ions such as standard ions.

The modification of polymer support substrates to obtain a support material as provided in step a) of the method has been described in PCT/EP2020/059908, its content is included herein in their entirety by reference.

The invention is at least partially based on the idea that the material as described in PCT/EP2020/059908 can be further improved by providing a coating with an oligo- or polyamine, in particular polyethyleneimine PEI, to reduce the effect of oxygen content in support particles on selectivity and thus to simplify the control over batch-to-batch reproducibility of the whole modification procedure. The coating with PEI additionally shields the substrate, so the interactions with the underlying surface are reduced. At the same time, the present invention shares the advantages of PCT/EP2020/059908 such as high chemical and mechanical stability and good column performance, while providing the possibility to control selectivity and column capacity independently from each other on different modification steps.

The polymer support substrate can typically be provided as particles, preferably as spherical particles, particularly preferably as spherical particles with an average particle size (median) of 1 to 50 μm, even more preferably with an average particle size of 2 to 25 μm, particularly preferably with an average particle size of 3 to 9 μm. However, other polymer support materials are also conceivable, especially polymer support materials in the form of membranes or monoliths. By spherical is meant that the particle has a sphericity value

$$Ψ = \frac{{{π}^{\frac{1}{3}} ( 6 {V}_{p} )}^{\frac{2}{3}}}{{A}_{p}}$$

of at least 0.80, preferably at least 0.90, more preferably at least 0.95, where V p is the volume of the particle and Ap is the surface area of the particle.

The oxygen content at the surface of the polymer support material can be increased by the initial oxidation and reduction or hydrolysis. Through the modification, hydroxy-groups can be originally generated on/in a core polymer support substrate that does not have a detectable oxygen content. The increased oxygen content can influence the type and characteristics of secondary interactions, especially the hydrophilicity of the resulting polymer support material. By a series of steps following the initial oxidation and reduction/hydrolysis, the capacity can be adjusted independently of the oxygen content at the surface.

The surface of the polymer support material or polymer support material surface is understood here in particular to mean the outer surface of the polymer support material structure which can be contacted by solution and the layer of 1 to 30 nm directly adjacent to this outer surface. The outer surface which can be contacted by solution can be partially located on microstructures, for example, on porous microstructures. In particular are envisaged the outer surface of polymer support substrate particles having porous or non-porous structures which can be contacted by solution.

A first contribution to chemical and mechanical stability can be made by a covalent bond between the polymer support material and a coating. This is in contrast to the use of latex-based ion exchangers, where purely electrostatic interactions provide for the position and orientation of exchange groups vis-á-vis the substrate. High chemical inertness is ensured due to covalent bonding. A second contribution to mechanical stability can be made by the fact that the core polymer support material is preferably at least partially formed from aromatic hydrocarbon compounds having at least two vinyl or allyl substituents, preferably at least partially from divinylbenzene monomers. The stability of this core polymer support substrate is not affected by any of the pre-treatment steps, such as the oxidative treatment and reductive and hydrolytic treatment. The core polymeric support substrate is preferably monodisperse.

The advantages of the high robustness of the particles become particularly apparent when a column packed with a polymer support material obtained by the above method is subjected to a pressure-flow test. In a pressure-flow test, the pressure development in the column is determined as a function of a continuously increased flow rate of mobile phase. In the column according to the invention, the pressure linearly depends on the flow rate. This is in contrast with results obtained with columns packed with conventional hydrophilic pDVB substrate having asubstantial vinyl acetate content. With conventional columns the pressure increases more than linearly with an increasing flow rate. For example, a hyperbolic slope of the function can result. This is shown, for example, in a publication of Çaglayan et al. (J Sep Sci 2006, 29, 940). According to the publication, an increased amount of vinyl acetate derived monomers and thus an increased amount of OH-groups in a hydrolyzed particulate substrate leads to a strong increase in back-pressure when the column packed with such substrate is exposed to increased flow rates.

A third aspect of the invention refers to a chromatography column, in particular ion exchange chromatography column, filled with a support material as previously described.

A fourth aspect of the invention refers to a method of chromatographic separation of analytes. A solution containing the analytes is contacted with polymer support material modified as previously described, in particular is passed through a chromatography column according to one aspect of the invention.

A fifth aspect of the invention refers to the use of a polymer support material as previously described and/or obtainable by a method as previously described for the analytical or preparative separation of analytes, in particular for use in anion exchange chromatography, cation exchange chromatography and/or in HILIC chromatography. The polymer support material is particularly suitable for use in suppressed ion chromatography.

The invention will be better understood by means of the following examples. The skilled person will, however, appreciate that variations are possible and well within the scope of disclosure.

The following figures illustrate:

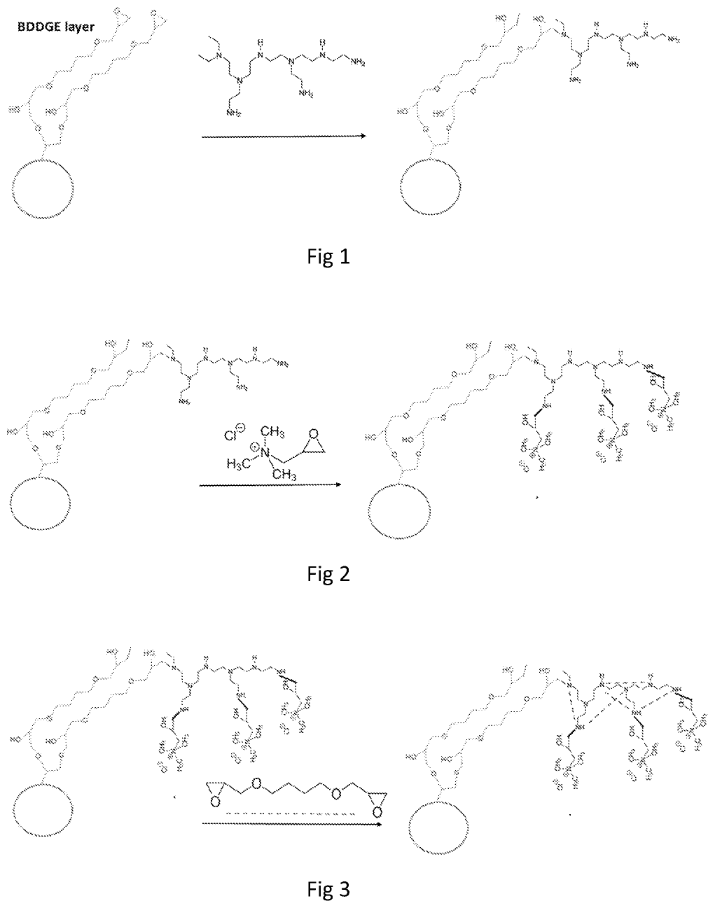

FIG. 1 Schematic representation of substrate modification with PEI;

FIG. 2 Schematic representation of modification with a compound baring an ion-exchange group;

FIG. 3 Schematic representation of modification with a crosslinking step;

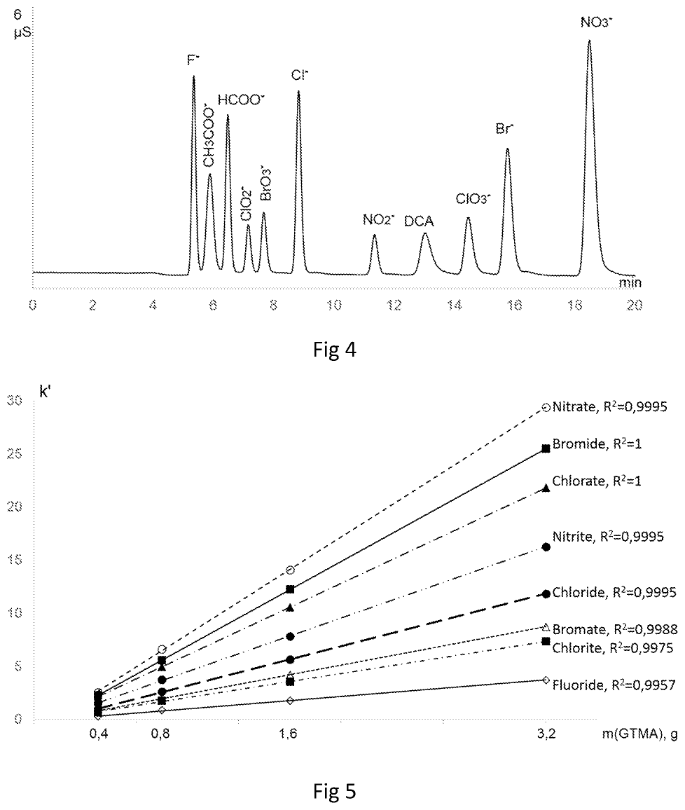

FIG. 4 Chromatogram obtainable with a polymer support material according to Example 6.2 in isocratic mode;

FIG. 5 Change in retention factor k′ depending on the amount of GTMA used in Example 5.1;

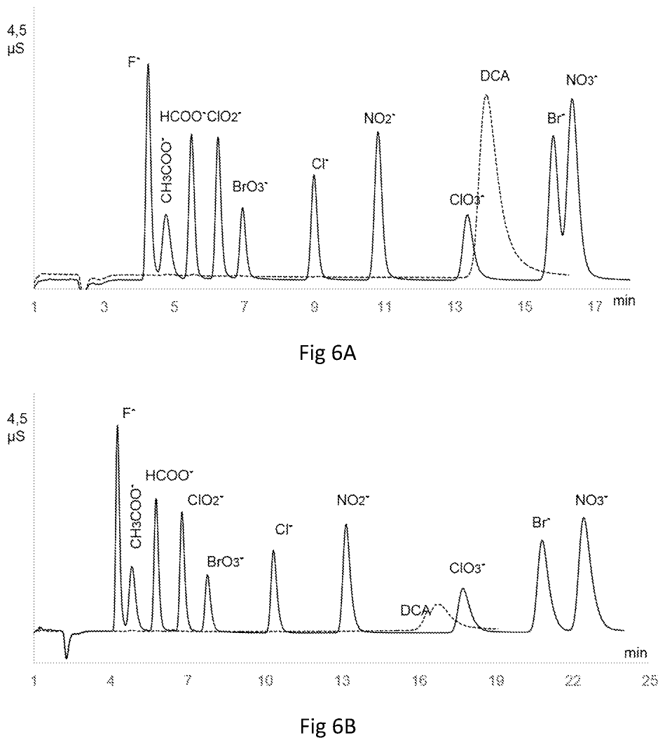

FIG. 6A, 6B Comparative chromatograms of performance of polymer support material according to Example 5.1 and 6.1;

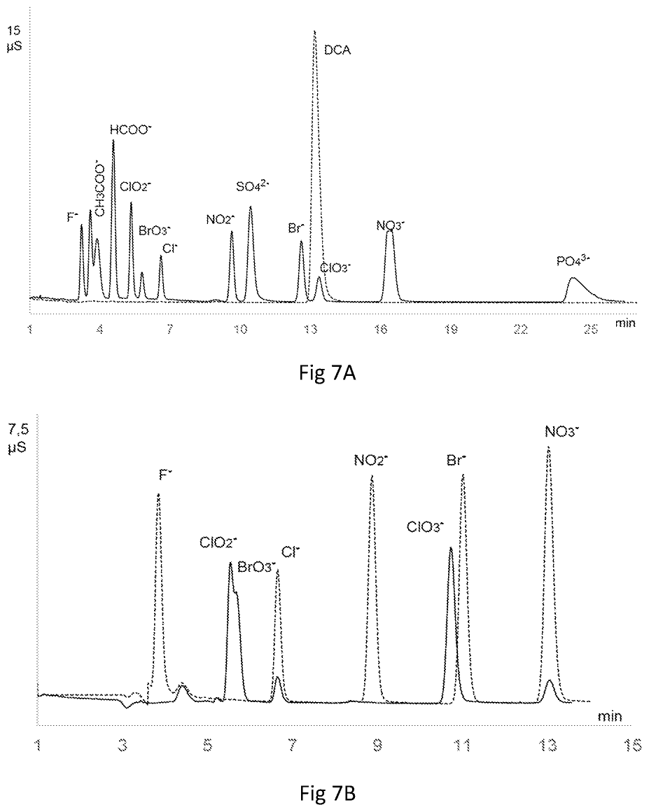

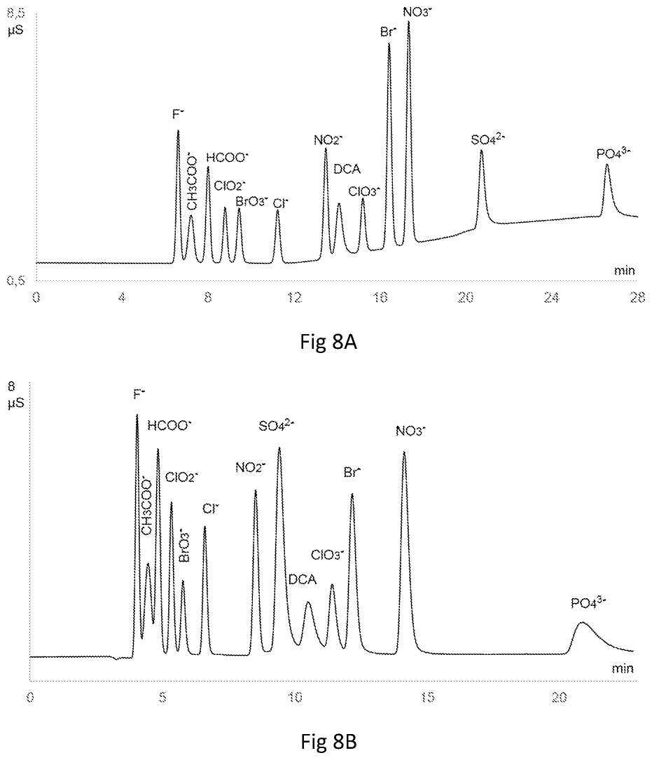

FIG. 7A, 7B Chromatograms of polymer support material according to comparative Example A in separating certain ions;

FIG. 8A, 8B Comparative chromatograms obtainable by polymer support material according to Example 6.2 with low and high crosslinking degree of the coating;

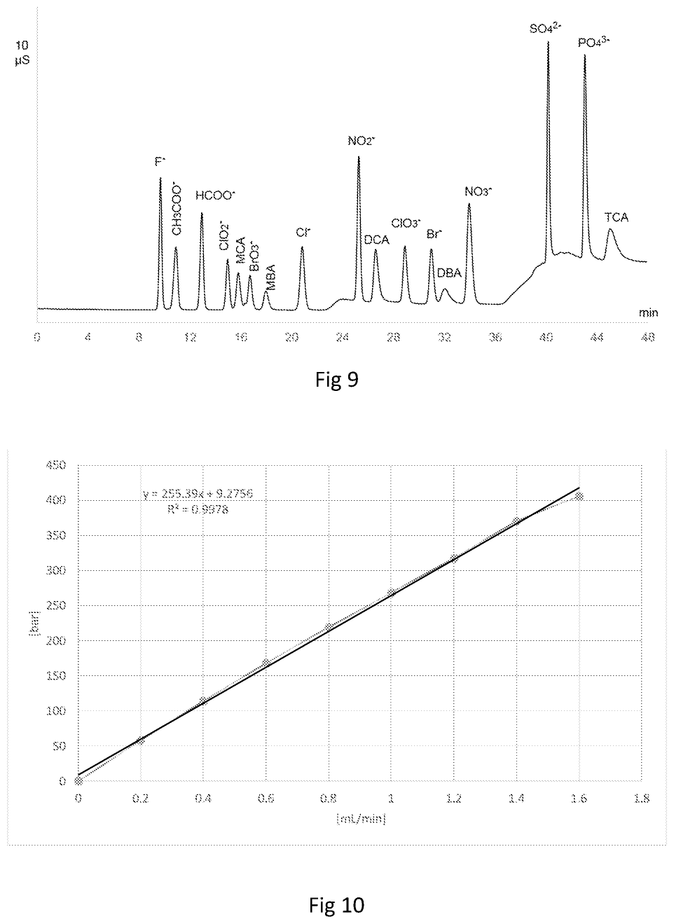

FIG. 9 Chromatogram obtainable by using a polymer support material according to Example 6.2 in gradient mode;

FIG. 10: Pressure-flow profile measured on a chromatography column filled with a polymer support material of the invention according to step a);

FIG. 11: Result of the particle size analysis by SEM (number over diameter [μm]);

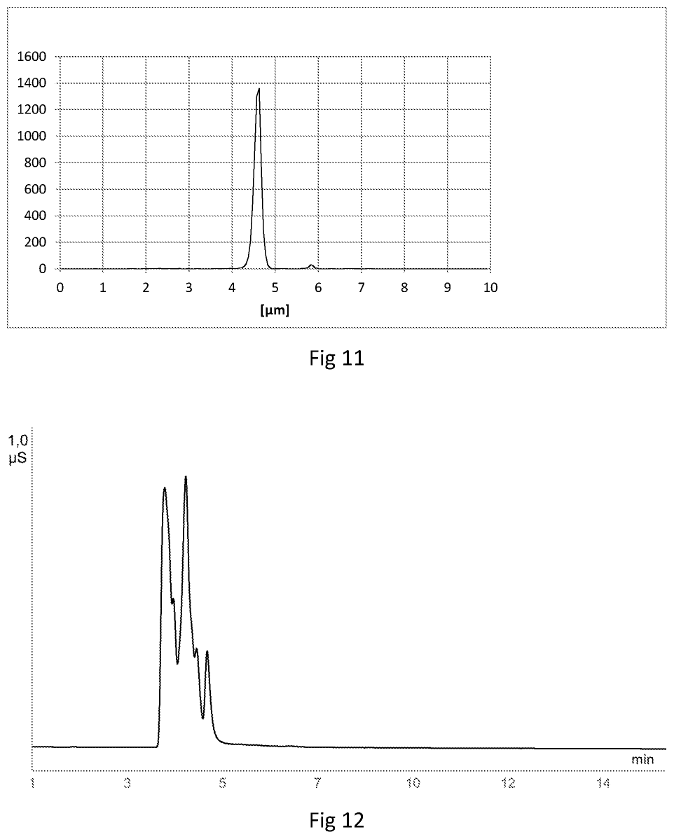

FIG. 12: Chromatogram of polymer support material according to example 14 in separating the same ions as in FIG. 4.

### EXAMPLE 1: PROVIDING A POLYMER SUPPORT SUBSTRATE

Polystyrene seed particles were prepared by dispersion polymerization of styrene in ethanol, stabilized with polyvinylpyrrolidone and initiated by means of azo-bis-iso-butyro-nitrile. Polystyrene particles having a mean diameter of 1.5 μm (Mn=15 kg/mol, Mw=55 kg/mol) were thus obtained. Polymerization was continued in an emulsion of 55 wt % divinylbenzene (DVB), 45% ethylvinylbenzene (EVB), toluene, in water/isoamyl alcohol, stabilized with polyvinylalcohol and initiated by means of azo-bis isobutyro-nitrile. Thus, porous highly crosslinked poly (DVB-EVB) particles having a mean radius of 4.6 μm, specific surface area of 540 m²/g, and a porosity of 1 cm₃/g were obtained.

### EXAMPLE 1.1: DETERMINING THE AVERAGE PORE RADIUS AND THE SPECIFIC SURFACE OF THE POLYMER SUPPORT SUBSTRATE

The average pore radius of the starting polymer support substrate was determined by nitrogen sorption in the BJH (Barret, Joyner, Halenda) model. The specific surface area was determined by nitrogen sorption in the BET model (Brunauer, Emmett, Teller). For both analyses a sample of 0.10945 g PS/DVB polymer support substrate was used. The density of the sample material was 1.105 g/cc. The measurement was performed on an Autosorb iQ S/N:14713051301 instrument in a 9 mm cell. The bath temperature was 77.35 K. The final degassing temperature was 60° C. The evaluation of the measurement was performed on Quantachrome ASiQwin version 3.01. The measurement was performed twice, once with a soaking time of 80 min, once with a soaking time of 40 min. The outgassing rate was 1.0° C./min and 20.0 C.°/min respectively. The mean pore radius resulting from the BJH method based on the pore volume was 5.1060 nm. The specific surface area according to the Multi-Point BET plot was calculated to be 540.0 m²/g.

### EXAMPLE 1.2: DETERMINING THE PRESSURE STABILITY OF THE POLYMER SUPPORT MATERIAL

An oxidation with hydrogen peroxide and a reduction with lithium aluminium hydride was carried out on the starting polymer support substrate. The resulting particle was subjected to a pressure test. For the pressure test, a 250×4 mm column was packed with the particle and water was passed through the column at an increasing flow rate. FIG. 10 shows a pressure-flow profile measured at room temperature. The y-axis shows the system pressure in bar. The x-axis shows the flow rate in mL/min. 8 intervals of 30 seconds each were measured, increasing the flow rate stepwise from 0.2 ml/min to 1.6 ml/min. As can be seen in the figure, the pressure is linearly dependent from the flow rate, up to pressures of 400 bar or 40 MPa.

### EXAMPLE 1.3: DETERMINING THE AVERAGE PARTICLE SIZE

The circularity and average particle diameter were determined for a sample of the starting polymer support material provided in step a. The sample was applied to a scanning electron microscope carrier in a single particle layer and coated with gold using a sputter-coater of the type LOT AutomaticSputterCoater MSC1 connected to a Vacubrand RZ 6 vacuum pump. A series of 27 images was taken using a scanning electron microscope (Phenom ProX) and individual particles were identified and measured using Olympus Imaging Solutions Scandium. The identified particles were analyzed for spherical diameter and roundness. All images were analyzed in batch processing with the same threshold values and measurement settings. A total of 6039 particles were measured with a circularity of ≥0.8. The measurement results are shown in FIG. 11. It shows on the y-axis the number of particles and on x-axis the diameter in μm. The smallest measured radii were 0.8 μm, the largest up to 10 μm. The mean diameter (median) was 4.6 μm, with a relative standard deviation of 6.2%. The polydispersity index PDI (Mw/Mn) found to be 1.04.

### EXAMPLE 2.1: GENERATING HYDROXY GROUPS

Oxidation with acetic acid: 61.7 g of the product of Example 1 were suspended in 382 mL acetic acid in a 1 L reactor connected to thermostat. Reaction mixture was heated to 80° C. 121 mL hydrogen peroxide (35%) was added slowly. The reaction mixture was stirred for 24 h, then cooled down and filtered off. The filter cake was washed with ultrapure water to neutral pH and flushed with ethanol. The filter cake was dried in a vacuum oven, to yield 66 g of product.

Reduction with lithium aluminum hydride: 51.7 g of the dried oxidized product were suspended in 196 mL of dry THF in a 1 L reactor and cooled to 5° C. with thermostat. 92 ml of 2.4M lithium aluminum hydride solution in THF were added carefully while stirring. The reaction mixture was heated to 55° C. and stirred for 48 h. The reaction was stopped by cooling down to 0° C. and adding 80 ml water within 60 minutes. After that, the reaction mixture was diluted and 150 ml sulphuric acid was added while stirring. The reaction mixture was heated to 80° C. for 1 h and filtered off afterwards. It was washed with water to neutral pH and flushed with acetone. The filter cake was dried to yield ca.50 g of product. The whole procedure was repeated twice.

### EXAMPLE 2.2: GENERATING HYDROXY GROUPS

Oxidation with acetic acid: 41 g of the product of example 1 was suspended in 300 mL acetic acid in a 1 L reactor with thermostat. Reaction was heated to 80° C. 79 mL of hydrogen peroxide (35%) was slowly added within 2 h. The reaction mixture was stirred for 18 h, then another portion of 79 ml of hydrogen peroxide was added and the mixture was stirred for another 4 h. The reaction mixture was cooled down, filtered off, washed with ultrapure water to neutral pH and flushed with ethanol. The filter cake was dried in a vacuum oven, to yield 45.1 g of oxidized product.

Reduction with lithium aluminum hydride: 41.3 g of the oxidized dried product was suspended in 434 mL of dry THF in a 1 L reactor and cooled to 0° C. with thermostat. 5.1 g lithium aluminum hydride was added carefully while stirring. The reaction mixture was heated to 55° C. and stirred for 20-24 h. The reaction was stopped by cooling down to 0° C. and adding 300 ml of water within 60 minutes. Then the reaction mixture was filtered off, the residue was re-suspended, and 41.3 ml 32% hydrochloric acid was added while stirring. The reaction mixture was heated to 80° C. overnight, then filtered off, washed with water to neutral pH and flushed with acetone. The filter cake was dried to yield ca. 39.8 g of the product. The whole procedure was repeated twice.

### EXAMPLE 3.1: PROVIDING A LINKER WITH TERMINAL EPOXY GROUPS

25 g of the reaction product of Example 2.1 was suspended in 93.75 mL dimethyl sulfoxide and 65.5 mL 1,4-butanediol diglycidyl ether. The flask was subjected to three vacuum/argon cycles. Under constant stirring, 37.5 mL NaOH (aq, 0.6M) was added and the reaction mixture was stirred for 26 h at 28° C. The product was filtered off, flushed with water and ethanol.

### EXAMPLE 3.2: PROVIDING A LINKER WITH TERMINAL EPOXY GROUPS

10 g of the reaction product of Example 2.2 was suspended in 37.5 mL dimethyl sulfoxide and 25 mL 1,4-butanediol diglycidyl ether. The flask was subjected to three vacuum/argon cycles. Under constant stirring, 25 mL NaOH (aq, 0.6M) was added and the reaction mixture was stirred for 22 h at 28° C. The product was filtered off, flushed with water and ethanol.

### EXAMPLE 4.1: PROVIDING A PEI LAYER

The product of Example 3.1 (substrate) was suspended in ethanol and water mixture. Polyethyleneimine PEI (CAS 25987-06-8) was dissolved in water, stirred and subjected to ultrasonication. The suspended particles and the dissolved PEI were combined and stirred for 23.5 h at 60° C. The weight ratio of PEI to substrate used was 0.4 g per 1 g. The product was filtered off and flushed with water. A schematic representation of the synthesis is provided in FIG. 1.

### EXAMPLE 4.2: PROVIDING A PEI LAYER

The procedure was the same as in Example 4.1, but the product of Example 3.2 was used as a substrate. A schematic representation of the synthesis is provided in FIG. 1.

### EXAMPLE 5.1: INTRODUCING AN ION EXCHANGE GROUP

The worked-up product of Example 4.1 was suspended in ethanol/water, stirred and sonicated. Glycidyltrimethylammonium chloride (GTMA, CAS 3033-77-0) was added, and the reaction mixture was stirred at 60° C. for 4 h. The weight ratio of GTMA to substrate used was 3.2 g per 1 g. The product was filtered off and flushed with water. A schematic representation of the synthesis according to Example 5.1 is provided in FIG. 2.

### EXAMPLE 5.2: INTRODUCING AN ION EXCHANGE GROUP

The procedure was the same as in Example 5.1, but the product of Example 4.2 was used as a substrate and amount of GTMA used was 0.8 g per 1 g of substrate. A schematic representation of the synthesis is provided in FIG. 2.

### EXAMPLE 6.1: CROSSLINKING

The worked-up reaction product of Example 5.1 was suspended in water. 1,4-butanediol diglycidyl ether (1,4-BDDGE, CAS 2425-79-8) was added and the mixture was stirred for 2.5 h at 60° C. The weight ratio of 1,4-BDDGE to substrate used was 2 ml per 1 g. The product was filtered off and flushed with water. A schematic representation of the synthesis according to example 6 is provided in FIG. 3.

### EXAMPLE 6.2: CROSSLINKING

The procedure was the same as in Example 6.1, but the product of Example 5.2 was used as a substrate. A schematic representation of the synthesis is provided in FIG. 3.

### EXAMPLE 7: ION CHROMATOGRAPHY

A 250×4 mm column was packed with ion exchange material obtained according to Example 6.2 and a solution of fluoride, acetate, formate, chlorite, bromate, chloride, nitrite, dichloroacetate, chlorate, bromide, nitrate was passed through the column at 20° C. using 9 mM KOH as a mobile phase with a flow rate of 0.8 ml/min. FIG. 4 shows a chromatogram obtained using such column. The ions elute separately each giving rise to a distinct and narrow peak.

### EXAMPLE 8: CONTROL OF CAPACITY

Capacity variation for ion-exchange material was provided by using different amounts of GTMA in the procedure according to Example 5.1. The effect of varying the amount of GTMA used (0.4 g, 0.8 g, 1.6 g, and 3.2 g) was established by measuring the retention factor k′ for all inorganic analytes from Example 7 in dependence thereof. The results are shown in FIG. 5. As can be seen from FIG. 5, retention of single-charged ions depends linearly on the amount of GTMA added, which allows to control the capacity of the column. At the same time, it was noted that selectivities for all prepared ion exchangers toward tested analytes (measured as retention factors of analytes divided by retention factor of chloride) were almost identical (relative standard deviation <5%) independently from capacity, which indicated that capacity has no effect on column selectivity towards inorganic anions.

### EXAMPLE 9: EFFECT OF SUBSTRATE AND LINKER ON SELECTIVITY

Selectivity coefficients for all analytes from Example 7 except for dichloroacetate relatively to chloride were determined using KOH as an eluent and compared for ion-exchange materials prepared according to Example 6.1 and Example 6.2. For preparing materials according to Example 6.2, the substrates obtainable by Example 3.2 when running the reaction for 16 h, 19 h, 22 h, and 23.5 h were used which provided different length and density of linkers for polyamine attachment. Selectivity coefficients for all analytes were almost identical in all cases, with relative standard deviation being less than 5%, which indicated that variations provided on the previous steps or any potential variations in the scaled-up production process in substrate modification degree and linker length and density had no significant effect on selectivity.

### EXAMPLE 10: EFFECT OF CROSSLINKING

The crosslinking step (see Example 6.1) has been described earlier as beneficial to the performance of an ion exchanger based on material according to the invention. A comparative study of a separation column (250×4) packed with ion exchanger material obtainable in Example 5.1 and in Example 6.1 respectively was performed. The analytes were fluoride, acetate, formate, chlorite, bromate, chloride, nitrite, dichloroacetate (DCA), chlorate, bromide, nitrate (KOH eluent, 40 mM, 1.0 ml/min). FIG. 6A shows a chromatogram obtainable by using the material according to Example 5.1. FIG. 6B shows a chromatogram obtainable by using the polymeric support material according to Example 6.1. Crosslinking allows for separate and distinct elution of DCA/chlorate and bromide/nitrate pairs.

### COMPARATIVE EXAMPLE A

A polymeric support material was prepared according to the teachings of Example 4 of EP 3 721 998 A1, except having replaced N-Methylpyrrolidine by N-Methylmorpholine in equal amount. FIG. 7A shows a chromatogram obtainable by using the material according to comparative Example A using KOH eluent. FIG. 7B shows a chromatogram obtainable by using the polymeric support material according to comparative Example A in the presence of other functionalities (NMP, MDEA). As can be seen from the figures, there is often co-elution of different ions of interest when using a polymeric support material according to comparative Example A.

### EXAMPLE 11: SELECTIVITY CONTROL

The crosslinking step (see Example 6.2) has been described earlier as beneficial to the performance of an ion exchanger based on material according to the invention. A low degree of crosslinking requires using the polymer support material in gradient elution mode because of the late elution of multiple-charged anions. A high degree of crosslinking allows for using the polymer support material in isocratic elution mode. Therefore, this step is responsible for control of column selectivity. A comparative study of a separator column (250×4) packed with ion exchanger material obtainable according to Example 6.2 with a high degree of crosslinking guaranteed by long reaction time (25 h) and with a low degree of crosslinking obtained by short reaction time (2.5 h) was performed. The analytes were fluoride, acetate/glycolate, formate, chlorite, bromate, chloride, nitrite, dichloroacetate, chlorate, bromide, nitrate, sulphate and phosphate, KOH was used as an eluent. FIG. 8A shows a chromatogram obtainable by using a polymer support material with low crosslinking degree of coating while using gradient elution (increasing KOH concentration during analysis). FIG. 8B shows a chromatogram obtainable by using a polymer support material with high crosslinking degree while using isocratic elution. Both chromatograms allow for clear and distinct separation of the analyte ions of interest, but material with high crosslinking degree allows for faster elution of polyvalent anions and does not require the use of gradient.

### EXAMPLE 12: EFFECT OF BATCH VARIATION

Three different batches of polymer support material according to Example 6.1 were synthetized. Three Columns (250×4 mm) were packed and mixture of analytes described in Example 7 was separated using KOH as an eluent in suppressed ion chromatography mode. Relative standard deviation (R.S.D) for retention times of all analytes was less than 5%, which indicates excellent batchto-batch reproducibility of material.

### EXAMPLE 13: SEPARATION OF INORGANIC STANDARD IONS AND HALOACETIC ACIDS

A polymer support material according to the present invention can serve as a basis to produce an anion exchanger which allows for the separation of 5 haloacetic acids in addition to the inorganic standard ions and oxohalides, preferably by using gradient elution with KOH. FIG. 9 shows a chromatogram obtainable by using a polymer support material according to Example 6.2. A separation column (250×4) packed with such ion exchanger material was prepared and an analyte solution comprising inorganic standard ions (F, Cl, ClO₂, ClO₃, Br, BrO₃, NO₂, NO₃, PO₄, SO₄) as well as acetate, formate, and five haloacetic acids (MCA, MBA, DCA, DBA, and TCA) was passed with KOH as an eluent through the said separation column (suppressed ion chromatography mode) using gradient elution mode. As can be seen from FIG. 9, all analytes elute separately, giving distinct peaks.

### EXAMPLE 14: EFFECT OF CHANGED ORDER STEPS D) AND C)

The worked-up product of Example 4 (PEI attachment) was treated according to example 6 (BDGE) followed by a treatment according to example 5 (GTMA). FIG. 12 shows a chromatogram obtained by using the polymer support material of example 14. As can be seen from the figure, there is co-elution of all ions of interest (same ions as in FIG. 4) when using a polymeric support material according to example 14.

1-24. (canceled)

25. A method for modifying a support material for use as a stationary phase in an analytical or preparative separation process, comprising the steps:
a) providing a support material,
b) coating the support material with an oligoamine or polyamine
c) reacting the support material with a compound comprising
a first functional group reactive with amines and/or hydroxy groups, preferably an epoxy group, and
an ion-exchange group, preferably a quaternary organo-element of main group V, preferably a quaternary ammonium group,
wherein step b) and c) are performed in sequence or simultaneously.

26. The method according to claim 26, wherein step c) is followed by a crosslinking step,
treating the reaction product resulting from step c) with one or more polyfunctional compounds.

27. The method according to claim 26, wherein the one or more polyfunctional compound in step d) has
at least a first functional group reactive with amines and/or hydroxy groups, and
at least a second functional group reactive with amines and/or hydroxy groups.

28. The method according to claim 23, wherein the first functional group is an epoxy group and wherein the second functional group is an epoxy group.

29. The method according to claim 25, wherein the oligoamine or polyamine in step b) is selected from the group consisting of polyallylamine, linear or branched polyethyleneimine (PEI), poly(2-methylaziridine).

30. The method according to claim 25, wherein the compound used in step c) is of Formula I 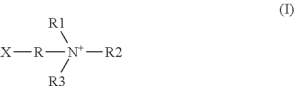
with R being a linear or branched alkyl or ether group;
with each of R1, R2 or R3 being selected independently from the group consisting of substituted or unsubstituted alkyl, substituted or unsubstituted heteroalkyl, substituted or unsubstituted aryl, substituted or unsubstituted heteroaryl, substituted or unsubstituted heterocycloaklyl or five- or six-membered heterocycle formed between R1 and R2 or R2 and R3 or R1 and R3 and
with X being the functional group reactive with amines and/or hydroxyl groups.

31. The method according to claim 30, wherein the compound is of formula I and R is selected from the linear or branched alkyl or ether group consisting of —(CH₂)ₙ— or —(CH₂)ₙ—O—(CH₂)ₙ— with n being selected from 1, 2, 3, 4, 5, 6, 7, 8, 9, 10; and
wherein R1, R2 and R3 each or independently being
an alkyl group selected from the group consisting of —CH₃ and —(CH₂)ₙ—CH₃, with n being selected from 1, 2, 3, 4, 5, 6, 7, 8, 9, 10; or
an alkyl alcohol group selected from the group of linear or branched alkyl alcohols, preferably selected from the group consisting of —(CH₂)ₙ—OH, with n=being selected from 1, 2, 3, 4, 5, 6, 7, 8, 9, 10.

32. The method according to claim 30, wherein the compound is of formula II, III or IV 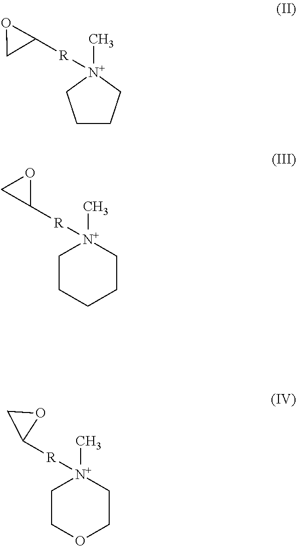
with R being selected from the linear or branched alkyl or ether group consisting of —(CH₂)ₙ— or —(CH₂)ₙ—O—(CH₂)ₙ— with n being selected from 1, 2, 3, 4, 5, 6, 7, 8, 9, 10.

33. The method according to claim 30, wherein the compound used in step c) is of Formula (I), selected from the group consisting of glycidyltrimethylammonium chloride; glycidylmethyldiethanolammonium chloride; and glycidyltriethylammonium chloride.

34. The method according to claim 30, wherein the compound used in step c) is a (Halogenoalkyl)trialkylammonium halogenide selected from the group consisting of:
(3-Chloro-2-hydroxypropyl)trimethylammonium chloride,
(2-Chloroethyl)trimethylammonium chloride,
(2-Bromoethyl)trimethylammonium bromide,
(3-Bromopropyl)trimethylammonium bromide,
(5-Bromopentyl)trimethylammonium bromide.

35. The method according to claim 26,
wherein the polyfunctional compound(s) used in step d) is/are selected from
epoxides;
halogenalkanes;
aldehydes.

36. The method according to claim 35, wherein the epoxides are selected from 1,4-butanedioldiglycidyl ether, trim ethylolpropane trig lycidyl ether, poly(ethylene glycol) diglycidyl ether, resorcinol diglycidyl ether, glycerol diglycidyl ether, glycidol; and wherein the halogenalkanes are selected from epichlorohydrin, epibromohydrin, 1,1′-Oxybis[2-(2-chloroethoxy)ethane]; and 1,2-Bis(2-chloroethoxy)ethane, bis(2-chloroethyl) ether, 1-Chloro-3-iodopropane, 1,4-dibromobutane, 1,3-dibromopropane; and wherein the aldehyde is glutaraldehyde.

37. The method according to claim 25 wherein the reaction product resulting from step c) is treated with one or more monofunctional compounds.

38. The method according to claim 37, wherein the monofunctional compound is a compound having a functional group reactive with amines and/or hydroxy groups.

39. The method according to claim 38, wherein the monofunctional compound is selected from the group consisting of substituted or unsubstituted alkyl, substituted or unsubstituted heteroalkyl, substituted or unsubstituted aryl, substituted or unsubstituted heteroaryl, substituted or unsubstituted heterocycloaklyl.

40. The method according to claim 38, wherein the monofunctional compound is selected from halogene alkanes or epoxy alkanes.

41. The method according to claim 25, wherein the PEI is covalently attached to the support material.

42. The method according to claim 41, wherein the PEI is attached to the support material by means of a spacer molecule.

43. The method according to claim 42, wherein the spacer is a polyfunctional molecule with a group reactive with alcohols/amines and the other group reactive with polyamine.

44. The method according to claim 43, wherein the support material provided in step a) comprises groups that are reactive with the spacer molecule on the substrate end.

45. The method according to claim 25, wherein the support material provided in step a) comprises groups that are reactive with epoxides.

46. The method according to claim 25, wherein the support material provided in step a) is selected from the group consisting of hydrocarbon-based compounds; PVA; sugar-based compounds; inorganic compounds.

47. The method according to claim 25, comprising the step of generating hydroxy groups on/in the support material, previous to step b), by a process comprising the steps of
oxidative treatment of the polymer support substrate; and subsequent
reductive or hydrolytic treatment.

48. The method according to claim 25, wherein the support material is
partially derived from aromatic hydrocarbon compounds having at least two vinyl or allyl substituents; and
partially derived from monomers selected from the group of ethylvinylbenzene, vinyl acetate, styrene and any combination thereof.

49. The method according to claim 48, wherein the relative amount of aromatic hydrocarbon compounds having at least two vinyl or allyl substituents is at least 50% by weight.

50. The method according to claim 25, wherein step c) or d) is followed by a step
e) heating the functionalized and crosslinked material in alkaline solution.

51. A support material for use as a stationary phase in an analytical or preparative separation process obtainable by a method according to claim 25.

52. The support material according to claim 51, wherein the support material provided in step a) is microporous or mesoporous.

53. The support material according to claim 51, wherein the material is stable in a pH range from 0 to 14.

54. The support material according to claim 53, wherein the material is stable in a pH range from 0 to 14 such that the retention time of sulfate in a column packed thereof after one-time rinsing with 1M NaOH solution and/or one-time rinsing with 1M HNO₃ solution does not differ by more than 8% from the retention time of sulfate before such rinsing.

55. A chromatography column filled with a support material according to claim 51.

56. A method of chromatographic separation of analytes, wherein a solution containing the analytes is contacted with polymer support material according to claim 51.
